(19) United States
(12) Patent Application Publication
(10) Pub. No.: US 2023/0006254 A1
(43) Pub. Date: Jan. 5, 2023

(54) AN ELECTROLYTE FOR MAGNESIUM-ION BATTERIES

(71) Applicant: AGENCY FOR SCIENCE, TECHNOLOGY AND RESEARCH, Singapore (SG)

(72) Inventors: Dan Thien NGUYEN, Singapore (SG); Zhi Wei SEH, Singapore (SG)

(21) Appl. No.: 17/780,489

(22) PCT Filed: Nov. 30, 2020
(86) PCT No.: PCT/SG2020/050707

§ 371 Date: May 26, 2022

(30) Foreign Application Priority Data
Dec. 4, 2019 (SG) 10201911677T

(51) Int. Cl. H01M 10/0568; H01M 10/0569; H01M 4/46; H01M 10/054; H01M 50/109

(52) U.S. Cl. CPC H01M 10/0568; H01M 10/0569; H01M 4/46; H01M 10/054; H01M 50/109; H01M 2004/027

(57) ABSTRACT

The present disclosure relates to an electrolyte comprising at least one magnesium salt having a polyatomic anion, an aluminium halide salt and a solvent comprising at least one ether group. The electrolyte described herein does not comprise magnesium chloride. The electrolyte described herein may be used in magnesium ion electrochemical cells.

### CROSS-REFERENCE TO RELATED APPLICATIONS

This application claims the benefit of priority of Singapore patent application No. 10201911677T, filed on 4 Dec. 2019, its contents being hereby incorporated by reference in its entirety.

### TECHNICAL FIELD

The present disclosure relates to an electrolyte system, in particular, to an electrolyte for use in magnesium ion batteries.

### BACKGROUND ART

The rapid development of electrical and electronic devices in recent years has renewed interest in the development of energy sources such as rechargeable batteries. Currently, lithium is relied upon heavily as an energy source for such electronic devices. However, there is concern that increasing demands for such lithium-ion batteries may further deplete the limited supply of lithium in the Earth's crust.

Various technologies have been researched and developed as alternatives to lithium ion batteries in recent years. Magnesium ion batteries have shown great potential as an alternative energy source due to its high natural abundance, high volumetric capacity, low reduction potential, and low cost. However, the development of such batteries has been hampered by poor performance of current electrolyte systems.

Due to the reactivity of magnesium-based electrodes, organic solvents are typically employed in electrolyte systems for magnesium ion batteries. While several magnesium salts have demonstrated good solubility in such organic solvents, electrolytes comprising these magnesium salts alone often result in poor Coulombic efficiency and poor reversibility of magnesium deposition. As such, the performance of magnesium-ion batteries has been regarded to be poorer than the current lithium-ion batteries

Accordingly, there is a need to provide an improvement for magnesium-ion batteries which are able to overcome or at least ameliorate the disadvantages discussed above. In particular, it is an object to provide an electrolyte system for magnesium ion batteries which allows efficient plating and stripping of magnesium and demonstrates improved Coulombic efficiency. Other desirable features and characteristics will become apparent from the subsequent detailed description and the appended claims, taken in conjunction with the drawings and this background of the disclosure

### SUMMARY OF INVENTION

In one aspect of the present disclosure, there is provided an electrolyte comprising a) at least one magnesium salt; b) an aluminium halide salt; and c) a solvent comprising at least one ether group; wherein the electrolyte does not comprise magnesium chloride; and wherein said magnesium salt comprises a polyatomic anion.

In another aspect of the present disclosure, there is provided an electrolyte consisting essentially of a) a magnesium salt; b) an aluminium halide salt; and c) a solvent comprising at least one ether group; wherein said magnesium salt comprises a polyatomic anion.

Advantageously, it was found that the combination of an aluminium halide salt and a polyatomic magnesium salt results in in-situ formation of electroactive ionic magnesium species which are highly soluble in the solvent comprising at least one ether group. Without being bound by theory, it is postulated that the electroactive species formed from the aluminium halide salt and polyatomic magnesium salt facilitates efficient charge transfer in the electrolyte. This enables efficient plating and stripping of magnesium at the electrode to be achieved and leads to sustained and stable Coulombic efficiency of about 80-95%, even after 250 cycles. In embodiments of the present invention described below, it was observed that the Coulombic efficiency may remain substantially stable over the battery's life, wherein the variance between each cycle may be ±10% or less. This is a marked improvement over the performance of other conventional magnesium-based electrolytes which tend to show erratic and irregular Coulombic efficiencies as the number of cycles increases.

The sustained and stable cycling behavior of the electrolyte described herein also advantageously leads to an extended cycling life of an electrochemical cell prepared with the electrolytes described herein. Electrochemical cells prepared with electrolytes described herein may be used for more than 250 cycles.

In yet another aspect of the present disclosure, there is provided an electrochemical cell comprising a) a positive electrode; b) a magnesium negative electrode; c) the electrolyte as described herein; and wherein said positive electrode and said magnesium negative electrode are in fluid communication with said electrolyte.

As will be demonstrated herein, electrochemical cells comprising the electrolytes as described herein exhibit a surprisingly long cycling life of at least 250 cycles. This is believed to be due to the formation of electroactive species such as Mg₂(μ-Cl)₂(solvent)₄]²⁺, which are highly soluble in the solvent comprising at least one ether group. The formation of such species may allow the deposition of uniform and dendrite-free layers of magnesium on an electrode in an electrochemical cell. The dendrite-free deposition of magnesium may reduce the occurrence of short-circuits in an electrochemical cell, thereby improving its usability and safety. A combination of one or more of the aforementioned technical effects may lead to a longer lifetime of the electrochemical cells assembled with the electrolytes described herein.

### Definitions

The term “stable”, “stability” and grammatical variants thereof, in the context of this specification, refers to an electrode that can be operated with no sign of short circuiting and/or without experiencing sudden fluctuations in voltage or current or capacity.

The term “homogenous” as used herein refers to substances which comprise components or elements which are the same. The term also refers to mixtures which contain a uniform distribution of components throughout. Homogenous mixtures may have the same composition of components or elements throughout. As described herein, homogenous mixtures may contain only one phase of matter, e.g. only liquid, solid or gas; while homogenous electrodes may contain only a single element.

The term “diameter” as used herein refers to the diameter of a substantially round or spherical pore. The pores described herein may be of a regular or irregular shape. Regular shaped pores may be spherical, cylindrical, oblong or ellipse. Where the pores are not spherical or irregular in shape, the particle diameter shall be taken to be the longest measured diameter of the pore.

The word “substantially” does not exclude “completely” e.g. a composition which is “substantially free” from Y may be completely free from Y. Where necessary, the word “substantially” may be omitted from the definition of the invention.

The term “polymer” as used herein refers to compounds which comprise multiple repeating units of a monomer. Polymers may be longer than oligomers and may comprise an infinite number of repeating units of a monomer. Polymers have long chains of repeating units and have high molecular weight.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. Exemplary, non-limiting embodiments of a carbonized composite for electrochemical cell electrodes, will now be disclosed

In a first aspect, the present disclosure relates to an electrolyte comprising a) at least one magnesium salt, b) an aluminium halide salt; and c) a solvent comprising at least one ether group, wherein the electrolyte does not comprise magnesium chloride and wherein said at least one magnesium salt comprises a polyatomic anion.

In embodiments, the electrolyte described herein consists essentially of a) a magnesium salt, b) an aluminium halide salt; and c) a solvent comprising at least one ether group, wherein said magnesium salt comprises a polyatomic anion.

In other embodiments, the electrolyte described herein consists of a) a magnesium salt, b) an aluminium halide salt; and c) a solvent comprising at least one ether group, wherein the electrolyte does not include magnesium chloride and wherein said magnesium salt comprises a polyatomic anion.

In the context of the present invention, the expression “electrolytes which do not comprise magnesium chloride” or variants thereof may be taken to mean that magnesium chloride is intentionally not added as a chemical constituent/ingredient during preparation of the electrolyte composition. Such electrolytes may, however, form electroactive or solvated species comprising magnesium and chloride ions in the solvent when the electrolyte is used in an electrochemical cell.

The aluminum halide salt used herein may be any aluminium halide salt which is soluble in the solvent comprising at least one ether group. The aluminum halide salt may be aluminium fluoride, aluminium chloride, aluminium bromide or aluminium iodide. In preferred embodiments, the aluminium halide salt used in the electrolyte is aluminium chloride.

Advantageously, it was found that aluminium chloride demonstrates good solubility in the solvent comprising at least one ether group as compared to other chloride salts such as sodium chloride, magnesium chloride and lithium chloride. The superior solubility of the aluminium chloride additive may, as a result, provide an increased concentration of chloride anions in the electrolyte. This enables the formation of electrochemically active species such as Mg₂(μ-Cl)₂(solvent)₄]²⁺, which facilitates charge transfer and contributes to the efficient plating and stripping of magnesium at the working electrode of an electrochemical cell. The benefits of providing aluminium chloride in the solvent may be demonstrated by the Examples provided herein, which show that cells comprising such electrolytes are able to exhibit a Coulombic efficiency of up to 95%.

The concentration of the aluminium halide salt in the electrolyte may be between about 0.01 M to 20 M, or about 0.01 M to 18 M, or about 0.01 M to 16 M, or about 0.01 M to 14 M, or between about 0.01 M to 12 M, or between about 0.01 M to 10 M, or between about 0.01 M to 8 M, or between about 0.01 M to 6 M, or between about 0.01 M to 5 M, or between about 0.01 M to 4 M, or between about 0.01 M to 3 M, or between about 0.01 M to 2 M, or between about 0.01 M to 1 M, or between about 0.01 M to 0.8 M, or between about 0.01 M to 0.6 M, or between about 0.05 M to 0.6 M, or between about 0.1 M to 0.6 M, or between about 0.2 M to 0.6 M, or preferably between about 0.2 M to 0.4 M. In embodiments, the aluminium halide salt is provided at a concentration of about 0.33 M.

The electrolyte described herein may comprise at least one magnesium salt. The electrolyte may comprise up to 10 magnesium salts. The electrolyte may comprise 1 to 10 magnesium salts, or 1 to 10 magnesium salts, or 1 to 9 magnesium salts, or 1 to 8 magnesium salts, or 1 to 7 magnesium salts, or 1 to 6 magnesium salts, or 1 to 5 magnesium salts, or 1 to 4 magnesium salts, or 1 to 3 magnesium salts, preferably 1 to 2 magnesium salts.

The magnesium salt of the electrolyte may be any magnesium salt which may form an electroactive species which facilitates charge transfer between electrodes of an electrochemical cell. The magnesium salt may preferably be a magnesium salt which is soluble in the solvent comprising at least one ether group. Where more than one magnesium salt is used, at least one magnesium salt may comprise a polyatomic anion. The polyatomic anion may comprise 2-50 atoms, or 5-50 atoms, or 5-45 atoms, or 5-40 atoms, or 5-35 atoms, or 5-30 atoms, or 5-25 atoms, or 10-25 atoms, or preferably 10 to 20 atoms. In embodiments, the polyatomic anion comprises 15 atoms.

The polyatomic anion of the magnesium salt may be chlorate, trifluoromethanesulfonate (OTf), phosphate, sulfate, sulfite, hexafluorophosphate, hexafluoroarsenate, bis(trifluoromethanesulfonyl)imide (TFSI), bis(fluorosulfonyl)imide (FSI), bis(butanesulfonyl) imide, cyanamide, oligomeric fluorosulfonyl imide, nonafluorobutanesulfonyl imide, bis(oxalato)borate (BOB), difluoro(oxalato)borate (DFOB), and tetrafluoroborate.

The polyatomic anion may preferably comprise at least one halogen atom, more preferably at least one fluorine atom. The polyatomic anion may preferably be trifluoromethanesulfonate (OTf), bis(trifluoromethanesulfonyl)imide (TFSI), bis(fluorosulfonyl)imide (FSI), oligomeric fluorosulfonyl imide, nonafluorobutanesulfonyl imide, difluoro(oxalato)borate (DFOB), and tetrafluoroborate. In embodiments, the polyatomic anion is a bis(trifluoromethanesulfonyl)imide (TFSI) anion and the magnesium salt used in the electrolyte is magnesium bis(trifluoromethanesulfonyl)imide, Mg(TFSI)₂.

It is further observed that a combination of the magnesium bis(trifluoromethanesulfonyl)imide [Mg(TFSI)₂] and aluminium chloride salt in a solvent comprising at least one ether group advantageously results in a homogenous electrolyte system. Without being bound by theory, the presence of the polyatomic anion of the magnesium salt is believed to contribute to the improved solubility of the magnesium salt in the solvent. This may in turn provide an optimal concentration of magnesium and chloride ions in the solution for the formation of electroactive species such as Mg₂(μ-Cl)₂(solvent)₄]²⁺. As discussed, the formation of such electroactive species may be able to facilitate efficient plating and stripping of magnesium, thereby improving the Coulombic efficiency of a battery.

The concentration of the magnesium salt in the electrolyte may be between 0.01 M to 20 M, or about 0.01 M to 18 M, or about 0.01 M to 16 M, or about 0.01 M to 14 M, or about 0.01 M to 12 M, or about 0.01 M to 10 M, or about 0.01 M to 8 M, or about 0.01 M to 6 M, or about 0.01 M to 5 M, or about 0.01 M to 4 M, or about 0.01 M to 3 M, or about 0.01 M to 2 M, or about 0.01 M to 1 M, or about 0.01 M to 0.8 M, or about 0.01 M to 0.6 M, or about 0.01 M to 0.5 M, or about 0.05 M to 0.5 M, or about 0.1 M to 0.5 M, or about 0.2 M to 0.5 M; or about 0.1 M to 0.4 M, preferably about 0.1 to 0.3 M. In embodiments, the magnesium salt in the electrolyte is provided at a concentration of 0.25 M.

The molar ratio of the magnesium salt to the aluminium halide salt in the electrolyte may be between about 5:1 to 1:10, or between about 5:1 to 1:8, or between about 5:1 to 1:6, or between about 5:1 to 1:4, or between about 5:1 to 1:2, or between about 4:1 to 1:2, or between about 3:1 to 1:2, or between about 2:1 to 1:2, or preferably between about 1:1 to 1:2. In embodiments, the molar ratio of the magnesium salt to the aluminium halide salt is about 1:1.32.

The electrolyte may comprise at least two or more magnesium salts. Where two or more magnesium salts are used in the electrolyte, the first magnesium salt may comprise a polyatomic anion as described herein. The second or subsequent magnesium salt may be any magnesium salt which may be compatible with other components of the electrolyte. The second or subsequent magnesium salt may comprise a monoatomic anion or a polyatomic anion, provided these magnesium salts are not magnesium chloride. The subsequent magnesium salt may preferably reduce flammability, protection and overcharging when used in an electrochemical cell.

Non-limiting examples of the second or subsequent salts include magnesium carbonate, magnesium sulfate, magnesium hydroxide, magnesium nitrate, magnesium citrate, magnesium iodide, magnesium bromide, magnesium fluoride, magnesium trifluoromethanesulfonate (OTf), magnesium phosphate, magnesium sulfate, magnesium sulfite, magnesium hexafluorophosphate, magnesium hexafluoroarsenate, magnesium bis(trifluoromethanesulfonyl)imide (TFSI), magnesium bis(fluorosulfonyl)imide (FSI), magnesium bis(butanesulfonyl) imide, magnesium cyanamide, magnesium nonafluorobutanesulfonyl imide, magnesium bis(oxalato)borate (BOB), magnesium difluoro(oxalato)borate (DFOB), and magnesium tetrafluoroborate.

Where two or more magnesium salts are used, the total concentration of the magnesium cation in the electrolyte is between 0.01 M to 20 M.

Without being bound by theory, it is believed that the performance of the electrolyte may be dependent on the ratio of magnesium ions in the magnesium salt to halide ions from the aluminium halide salt. The molar ratio of the magnesium cation of the magnesium salt to the halide anion in the aluminium halide salt may be between about 2:1 to 1:30, or between about 2:1 to 1:25, or between about 2:1 to 1:20, or between about 2:1 to 1:18, or between about 2:1 to 1:16, or between about 2:1 to 1:14, or between about 2:1 to 1:12, or between about 2:1 to 1:10, or between about 2:1 to 1:8, or between about 2:1 to 1:6, or between about 2:1 to 1:5, or between about 1:1 to 1:5, or between about 1:2 to 1:5, or preferably between 1:3 to 1:5. In embodiments, the molar ratio of the magnesium cation to the halide anion is about 1:4.

In preferred embodiments, the magnesium salt is Mg(TFSI)₂ and the aluminum halide salt is aluminium chloride, and wherein the molar ratio of the magnesium cation to the chloride anion in the electrolyte is between 1:1 to 1:5, and more particularly between 1:3 to 1:5, e.g about 1:4.

Advantageously, it was observed that electrolytes which comprise a magnesium cation:halide anion ratio described above led to stable cycling behavior of an electrochemical cell. In one embodiment, an electrochemical cell containing an electrolyte with a Mg:Cl ratio of 1:4, demonstrated a Coulombic efficiency which was successfully maintained at about 80-90% for more than 50 cycles. The provision of the cation/anion ratios as described herein may be optimal for the formation of stable electroactive species for charge transfer between two electrodes of an electrochemical cell. It is also postulated that at such ratios, degradation of the electrolyte during cycling is also minimal, which results in improved cycling life of more than 250 cycles. The solvent which is used to form the electrolyte may be any solvent which is compatible with the magnesium salt and the aluminium halide salt. For instance, the solvent may be any solvent which may dissolve the magnesium salt and aluminium halide salt and any electroactive species formed therefrom. Solvents which are able to dissolve the magnesium salt and aluminium halide salt may allow the preparation of homogenous liquid-based electrolytes.

The solvent used in the present electrolyte may be any ether solvent which is stable at room temperature. The solvent may preferably be a solvent which is not volatile at room temperature. The solvent which may be suitably used in the electrolyte may have a boiling point which is above room temperature. At room temperature and pressure, the boiling point of the solvent may be more than 40° C., or more than 50° C., or more than 60° C. or preferably more than 70° C., more preferably more than 80° C.

The solvent comprising at least one ether group may comprise an aromatic or aliphatic group. The solvent may be a cyclic aliphatic ether solvent or an open chain ether solvent. The ether solvent may comprise between 1 to 50 carbon atoms, or between 1 to 45 carbon atoms, or between 1 to 40 carbon atoms, or between 1 to 35 carbon atoms, or between 1 to 30 carbon atoms, or between 1 to 25 carbon atoms, or between 1 to 20 carbon atoms, or between 1 to 15 carbon atoms, or between 1 to 10 carbon atoms, or between 2 to 10 carbon atoms, or between 2 to 8 carbon atoms, more preferably between 2 to 6 carbon atoms. In preferred embodiments, the solvent comprises 4 carbon atoms.

The number of ether groups in the solvent may be between 1 to 20, or between 1 to 18, or between 1 to 16, or between 1 to 14, or between 1 to 12, or between 1 to 10, or between 1 to 8, or between 1 to 6, or preferably between 1 to 5 ether groups. In preferred embodiments, the solvent in the electrolyte comprises 2 ether groups.

The solvent which may be suitably used may be selected from the group consisting of tetrahydrofuran, monoglyme, diglyme, triglyme, tetraglyme, dioxane, tetrahydropyran, 1,4-dioxane and combinations thereof. The solvent may preferably be monoglyme, diglyme, triglyme or tetraglyme. In preferred embodiments, the solvent of the electrolyte is monoglyme.

Advantageously, the use of monoglyme in the claimed electrolyte results in higher initial Coulombic efficiency. In particular, an electrochemical cell comprising electrolytes prepared with monoglyme demonstrates an initial Coulombic efficiency of about 64%. The use of this solvent was also surprisingly found to contribute to longer cycle life and lower magnesium plating/stripping potential, which improves the energy density of the battery. Without being bound by theory, these advantageous effects are thought to be due to the low viscosity of monoglyme which enables efficient charge transfer between the electrodes of an electrochemical cell.

The solvent which may be a solvent which is not reactive with the magnesium salt and aluminium halide salt. This implies that the aluminium halide salt and magnesium salt may remain stable in the solvent. The solvent used in the electrolyte described herein may preferably be dry solvents, more preferably ultra-dry solvents.

Solvents which may be suitably used may comprise less than 200 ppm water, or less than 180 ppm water, or less than 160 ppm water, or less than 140 ppm water, or less than 120 ppm water, or less than 100 ppm water, or less than 80 ppm water, or less than 60 ppm water, or less than 40 ppm water, preferably less than 20 ppm. The solvent may more preferably be substantially free of water. In embodiments, ultra-dry solvents comprising less than 20 ppm water or substantially free of water were used in the electrolyte. As such, the electrolyte also comprised less than 200 ppm water, preferably less than 20 ppm water.

In another aspect, the present disclosure also provides an electrochemical cell comprising a) a positive electrode; b) a magnesium negative electrode, c) the electrolyte as described herein, wherein said positive electrode and said magnesium negative electrode are in fluid communication with said electrolyte. The electrochemical cell described herein may be operable at room temperature with or without the application of external heat.

The positive electrode as described herein may comprise an active material. The active material of the positive electrode may be fabricated from composites which are electrically conductive. Non-limiting examples of such composites include composites of sulfur and carbon materials such as carbon black, porous carbon, graphene, graphene oxide, hard carbon, graphite or combinations thereof.

The active complex may also be formed from a complex comprising at least one metal, preferably one or two metals. The complex may be of the formula MₓA_{y}, wherein M is a metal element; A is a halogen or chalcogenide; and x and y are integers of more than 0.

The metal M of the complex may be a transition metal. Suitable transition metals which may be used to form the complex include gold, silver, palladium, platinum, copper, molybdenum, nickel, tungsten, vanadium, cobalt or combinations thereof, preferably copper, molybdenum, nickel, tungsten, vanadium, cobalt or combinations thereof.

Component A of the complex may be a chalcogenide or a halogen. Component A of the complex may be selected from the group consisting of oxygen, sulfur, selenium, fluorine, chlorine, bromine or iodine.

The complex may be a cationic, neutral or anionic species. The complex may be reacted with reactive metal species to provide an active material of the formula RₙMₓA_{y}, wherein R is a reactive metal and n is an integer of more than zero. Non limiting examples of reactive metals R include sodium, magnesium and lithium.

Suitable composites or complexes which may be used for the fabrication of the positive electrode include sulfur/mesoporous carbon, sulfur/active carbon cloth, molybdenum sulfur complex (Mo₆S₈), copper sulfide (CuS), vanadium oxide (V₂O₅), vanadium sulfides (VS₄ and VS₂), manganese oxide (MnO₂) and copper selenide (CuSe).

The active material may be mixed with a conductive material such as carbon for the fabrication of an electrode. The mixture of the active material and conductive material may be coated on a conductive substrate using polymeric compounds. Such polymeric compounds may act as adhesives to bind the conductive material and active material for the fabrication of an electrode for an electrochemical cell. Polymeric compounds such as polyvinylidene fluoride, carboxymethyl cellulose, polyacrylic acid or mixtures thereof may be used for this purpose.

Conductive substrates which may be used for assembly of an electrochemical cell may be made of a metal. Non-limiting examples of such metals include aluminium, nickel, stainless steel, platinum, silver or gold.

The positive electrode may be provided in any 2-dimensional or 3-dimensional form for fabrication of an electrochemical cell. Similarly, the magnesium negative electrode may be provided in any size or shape which may be suitable for the fabrication of an electrochemical cell. In embodiments, the magnesium negative electrode may be provided as a solid magnesium disk for fabrication of a coin cell.

The electrochemical cell as described herein may be assembled with a separator. The separator may be placed between the positive electrode and the magnesium negative electrode. The electrolyte as described herein may be absorbed onto the separator which is placed between the two electrodes in the electrochemical cell. The absorption of the electrolyte by the separator allows the positive electrode and magnesium negative electrode to remain in fluid communication.

The absorption of the electrolyte as described herein by the separator is aided by the presence of pores. The pores on the separator may allow the retention of the electrolyte on the separator. The separator may be fabricated with pores of about 10 to 1000 nm in diameter.

The separator may be formed from natural or synthetic absorbent materials. The separator may also be provided in the form of a non-woven fiber or a membrane. Non-limiting examples of materials which may be use to fabricate the separator include polymers such as polyesters, polyamines, polycarbonates, polyimides, polyolefins, polyethylene, polyethylene terephthalate, polypropylene, polyvinylidene fluoride, poly(methyl methacrylate), polytetrafluoroethylene, polyvinyl alcohol, polyvinyl chloride, polyethylene glycol, polyacrylonitrile, polyethylene oxide or derivatives thereof.

The separator may also be fabricated from polymer-ceramic blends. Ceramic materials which may be suitable for the fabrication of the separator include calcium carbonate, oxides, nitrides or carbides of aluminium, zirconium, silicon, tin, cerium, yttrium and/or derivatives thereof. Natural materials such as latex, paper, cellulose and wood may also be used for the fabrication of separators.

Accordingly, the present disclosure provides an electrolyte which demonstrates promising performance in a magnesium-ion battery. This electrolyte system demonstrates efficient plating and stripping of magnesium, high Coulombic efficiency, long cycle life, good ionic conductivity and low overpotential when used in an electrochemical cell.

### BRIEF DESCRIPTION OF DRAWINGS

FIG. 1 is a representation of an exemplary 2032 coin cell which may be assembled. The asymmetric cell utilizes a carbon coated aluminium foil as the working electrode and a magnesium disk as a counter electrode.

FIG. 2a is a cyclic voltammogram obtained using a carbon-coated aluminium foil working electrode immersed in 0.25 M Mg(TFSI)₂ and 0.33 M AlCl₃ in monoglyme. FIG. 2b depicts the linear sweep voltammogram of a carbon coated aluminium foil working electrode in an electrolyte comprising 0.25 M Mg(TFSI)₂ and 0.33 M AlCl₃ in monoglyme. The voltammograms were obtained using magnesium as the reference electrode and counter electrode at a scan rate of 25 mV/s.

FIG. 3a is a voltage profile of the plating and stripping of magnesium on a carbon-coated aluminium electrode in an electrolyte comprising 0.25 M Mg(TFSI)₂ and 0.33 M AlCl₃ in monoglyme. A solid magnesium electrode was used as the reference and counter electrode. FIG. 3b is a plot of the cell voltage which was measured during the galvanostatic plating and stripping of magnesium in an aluminium-carbon/magnesium cell having an electrolyte comprising 0.25 M Mg(TFSI)₂ and 0.33 M AlCl₃ in monoglyme. The galvanostatic plating/stripping was conducted at a current density of 0.5 mA/cm², areal capacity of 0.1 mAh/cm², and cut-off voltage at 1.2V.

FIG. 4 is a plot of the Coulombic efficiency of a magnesium ion cell assembled with an aluminium-carbon working electrode and magnesium disc reference and counter electrode in an electrolyte comprising various concentrations of Mg(TFSI)₂ and AlCl₃ in monoglyme.

FIG. 5a is a voltage profile of the plating and stripping of magnesium on a carbon-coated aluminium working electrode in an electrolyte comprising 0.25 M Mg(TFSI)₂ and 0.33 M AlCl₃ in diglyme. FIG. 5b is the voltage profile of magnesium plating and stripping on the aluminium-carbon working electrode in a solution of 0.25 M Mg(TFSI)₂ and 0.33 M AlCl₃ in triglyme. FIG. 5c is the voltage profile of the plating and stripping of magnesium on an aluminium-carbon working electrode in 0.25 M Mg(TFSI)₂ and 0.33 M AlCl₃ in tetraglyme. In these measurements, a magnesium disc was used as the reference and counter electrode. The individual plots in each voltage profile were recorded at cycle 1, 2, 10, 20 and 50, as indicated. FIG. 5d is a plot of the Coulombic efficiency of the plating and stripping of magnesium in 0.25 M Mg(TFSI)₂ and 0.33 M AlCl₃ in various solvents using an aluminium-carbon working electrode and a magnesium counter and reference electrode.

FIG. 6a is the voltage profile of magnesium plating and stripping on a carbon coated aluminium foil electrode in contact with an electrolyte having 0.25 M Mg(TFSI)₂ and 0.33 M AlCl₃ dissolved in monoglyme. A magnesium disc was used as the reference and counter electrode. The individual plots in the voltage profile were recorded after the first, second, tenth, twentieth and fiftieth cycle. FIG. 6b is a plot of the Coulombic efficiency of the magnesium plating and stripping in a magnesium ion cell assembled with an aluminium-carbon working electrode, magnesium disc reference and counter electrode and an electrolyte having 0.25 M Mg(TFSI)₂ and 0.33 M AlCl₃ dissolved in monoglyme. The voltage profile and Coulombic efficiency was recorded at 0.5 mAh/cm². FIGS. 6c and 6d are scanning electron micrographs of a magnesium deposit on a carbon-coated aluminium working electrode at different scales. FIG. 6e is an energy dispersive X-ray spectrum (EDS) of a magnesium layer deposited on a carbon-coated aluminium working electrode of the magnesium-ion batteries.

FIG. 7 is a plot of the Coulombic efficiency of aluminium-carbon/magnesium cells comprising an electrolyte having various concentrations of AlCl₃ dissolved in monoglyme.

### EXAMPLES

Non-limiting examples of the invention will be further described in greater detail by reference to specific Examples, which should not be construed as in any way limiting the scope of the invention.

In the study of voltage profiles and Coulombic efficiencies below, the asymmetric magnesium ion electrochemical cell was galvanostatically cycled with a current density of 0.5 mA/cm². An areal capacity of 0.1 mAh/cm² or 0.5 mAh/cm² of Mg was plated onto an aluminium-carbon working electrode and the magnesium layer was stripped at current density of 0.5 mA/cm² until the voltage reached 1.2V. The Coulombic efficiency was calculated as the ratio of stripping capacity to plating capacity.

### Example 1. Fabrication of an Electrochemical Cell

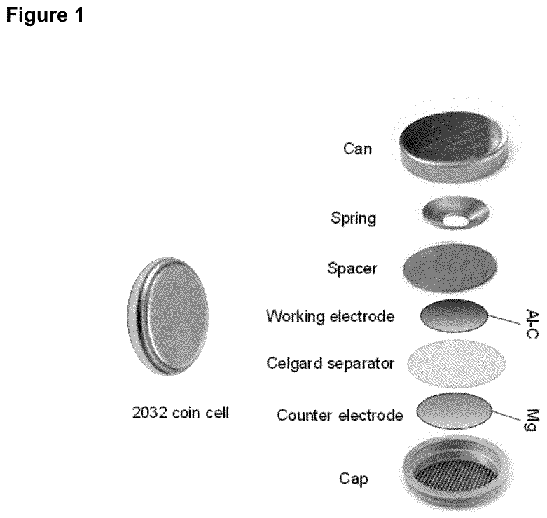

The electrochemical performance of the electrolyte described herein was evaluated by fabricating a 2032 coin cell comprising the electrolyte, as illustrated in FIG. 1. Unless described otherwise, the coin-cell configuration described below was adopted for the electrochemical studies of the electrolytes described herein.

An electrolyte was first prepared by dissolving Mg(TFSI)₂ and AlCl₃ at concentrations specified described below in monoglyme. A coin-cell type electrochemical cell was fabricated using a polished Mg disk having an area of 1.27 cm² as a counter electrode (also used as a reference electrode), 2 layers of Celgard separator, an Al—C disc (carbon-coated aluminum foil) having an area of 1 cm² as a working electrode and 25 μl of Mg(TFSI)₂—AlCl₃ electrolyte.

### Example 2. Reversibility of Magnesium Deposition

The reversibility of magnesium deposition on the positive electrode was also studied via cyclic voltammetry.

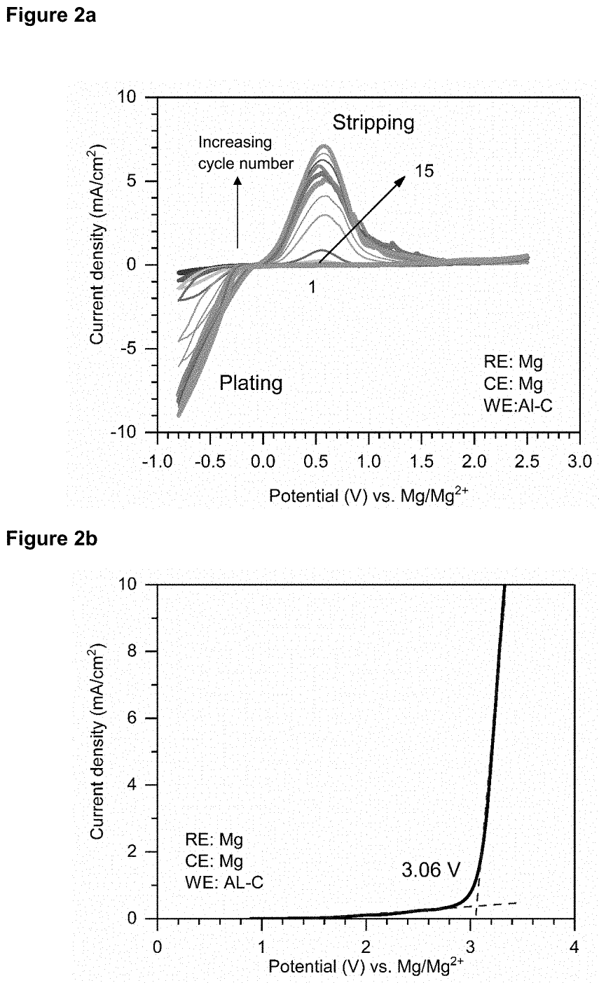

An electrochemical cell was fabricated with a positive electrode formed from carbon coated on aluminium (working electrode) and a magnesium electrode as the reference electrode and counter electrode. The electrodes were immersed in an electrolyte comprising 0.25 M Mg(TFSI)₂ and 0.33 AlCl₃ in monoglyme. Cyclic voltammograms were recorded at a scan rate of 25 mV/s and are illustrated in FIG. 2.

A cyclic voltammogram of the Al—C electrode in 0.25 M Mg(TFSI)₂ and 0.33 M AlCl₃ in monoglyme is shown in FIG. 2a. An enhancement in the reversibility of the magnesium deposition process is clearly observed during the first 15 cycles, expressed by lower overpotentials and higher cycling efficiencies. The current peak of anodic scan reaches 7.1 mA/cm² at 15th cycle. The linear sweep voltammogram shown on FIG. 2b shows an anodic stability of 3.06V.

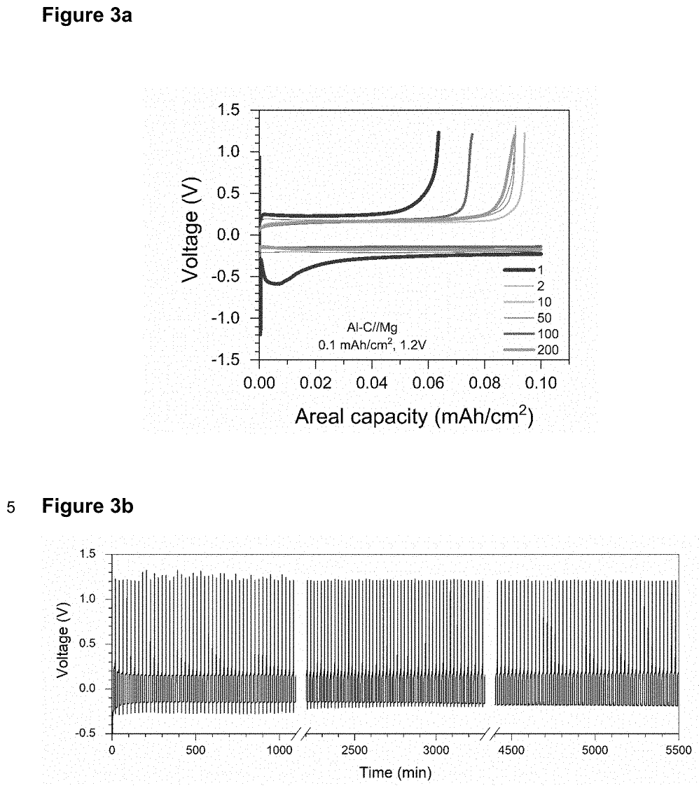

The voltage profiles of the plating and stripping of magnesium on the Al—C electrode were also studied. In the electrolyte of 0.25 M Mg(TFSI)₂ and 0.33 M AlCl₃ in monoglyme, reversible plating and stripping of Mg on Al—C foil were observed near −0.15 V and 0.15 V vs. Mg/Mg²⁺ (FIG. 3a). In the first cycle, Coulombic efficiency of the cell was observed to be relatively high (64%). The irreversible capacity (36%) in the first cycle is likely due to reduction of electrolyte components and/or contaminants (e.g. moisture). With increased cycle number, Coulombic efficiency of the cell increases significantly and reaches 95% in subsequent cycles. The stability of the plating and stripping behaviour is also demonstrated in the stable plotting voltage over up to 5500 minutes (FIG. 3b).

### Example 3. Effect of Concentration of Aluminium Halide Salt on Electrolyte Performance

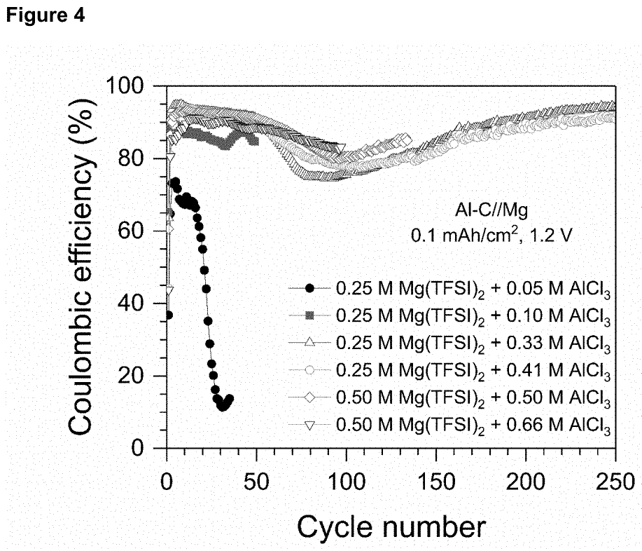

Electrolytes having different concentrations of Mg(TFSI)₂ and aluminium chloride in monoglyme were prepared for the fabrication of an electrochemical cell having an aluminium-carbon working electrode, a magnesium disc counter electrode (also used as a reference electrode). The plating and stripping profiles of magnesium-ion electrochemical cells comprising these electrolytes were studied and the results of the studies are shown in Table 1. Plots of the Coulombic efficiency of the electrochemical cells comprising electrolytes having various concentrations of AlCl₃ and Mg(TFSI)₂ in monoglyme are also provided in FIG. 4.

TABLE 1
Columbic efficiency of aluminium-carbon// magnesium
cells in electrolytes having various concentrations of
Mg(TFSI)₂—AlCl₃ monoglyme

| | Initial | Highest | |
|---|---|---|---|
| | Coulombic | Coulombic | Cycle |
| Electrolyte Composition | efficiency (%) | efficiency (%) | life |
| 0.25M Mg(TFSI)₂ and 0.05M | 37 | 74 | 35 |
| AlCl₃ in monoglyme | | | |
| 0.25M Mg(TFSI)₂ and 0.10M | 65 | 89 | 49 |
| AlCl₃ in monoglyme | | | |
| 0.25M Mg(TFSI)₂ and 0.33M | 64 | 95 | >250 |
| AlCl₃ in monoglyme | | | |
| 0.25M Mg(TFSI)₂ and 0.41M | 44 | 94 | >250 |
| AlCl₃ in monoglyme | | | |
| 0.25M Mg(TFSI)₂ and 0.50M | 61 | 93 | 207 |
| AlCl₃ in monoglyme | | | |
| 0.25M Mg(TFSI)₂ and 0.66M | 44 | 91 | 98 |
| AlCl₃ in monoglyme | | | |

Among these electrolyte compositions, the magnesium ion cell comprising an electrolyte with a combination of 0.25 M Mg(TFSI)₂ and 0.33 M AlCl₃ in monoglyme shows highest Coulombic efficiency. This cell also delivers the highest initial Coulombic efficiency (64%) and the highest Coulombic efficiency was recorded at 95% in subsequent cycles. Long cycle life (above 250 cycles) was also achieved at this composition.

It should also be noted that the cycle life of the Al—C/Mg cell, which uses 0.25 M Mg(TFSI)₂ and 0.5 M MgCl₂ in monoglyme as an electrolyte, is limited to 100 cycles under the same experimental conditions in prior work. Therefore, the Mg(TFSI)₂—AlCl₃ electrolyte system demonstrates significant enhancement of cycle life compared to combinations of Mg(TFSI)₂ and other halide-containing salts.

In addition, 0.25 M Mg(TFSI)₂ and 0.33 M AlCl₃ in monoglyme demonstrated high ionic conductivity of 4.95 mS/cm at 26.6° C. At higher concentrations of Mg(TFSI)₂ (0.5 M), the cells show lower Coulombic efficiency, which is likely due to high viscosity of electrolyte solution and increased concentration of contaminants.

### Example 4. Reversible Plating and Stripping of Magnesium in Ether Solvents

Electrolytes comprising 0.25 M Mg(TFSI)₂ and 0.33 M AlCl₃ dissolved in diglyme, triglyme and tetraglyme were prepared.

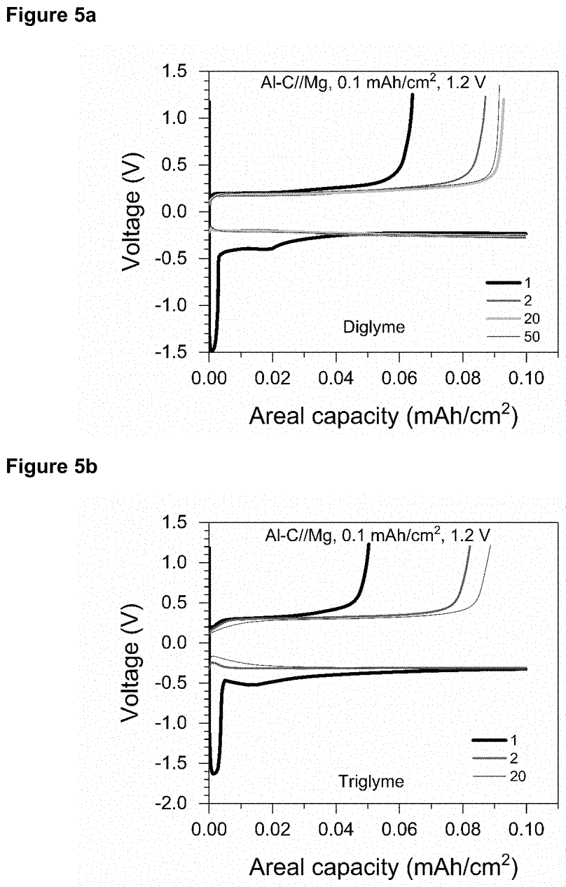

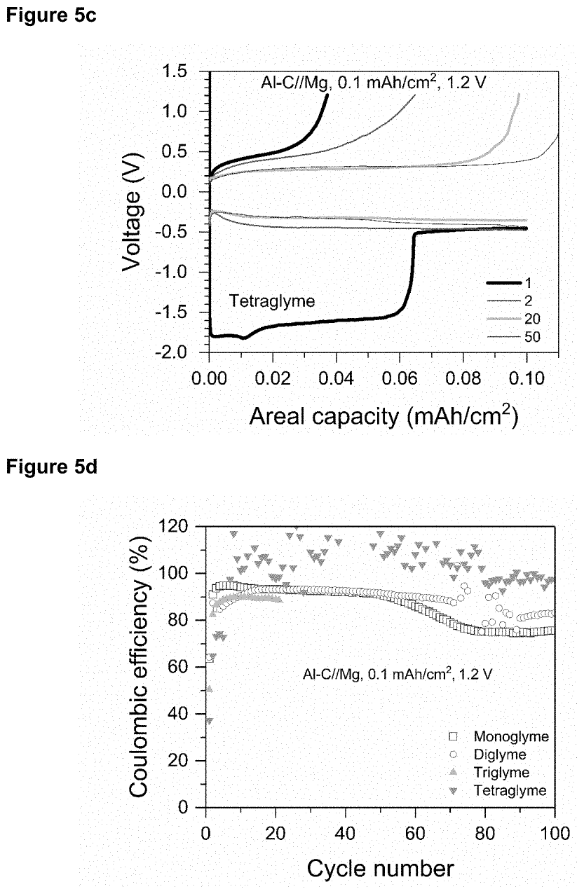

Electrochemical cells comprising a carbon coated aluminium working electrode, magnesium disc counter electrode (also used as a reference electrode) and the prepared electrolytes were assembled. The plating and stripping of magnesium on the working electrode in the presence of the electrolytes prepared with diglyme, triglyme and tetraglyme may be observed from the voltage profiles shown in FIGS. 5a to 5c. The Couloumbic efficiency of these electrochemical cells comprising electrolytes prepared with monoglyme, diglyme, triglyme and tetraglyme are also shown on FIG. 5d.

Reversible plating or stripping of magnesium is observed in all electrochemical cells studied herein. This implies that all solvents used in the preparation of the electrochemical cells facilitate reversible plating and stripping of magnesium. Among these solvents, diglyme was considered to be a promising alternative solvent for the Mg(TFSI)₂—AlCl₃ electrolyte system. The diglyme-based electrolyte delivers high initial Coulombic efficiency of 64% and maintains above 90% for 50 cycles.

### Example 5. Homogenous Growth of Magnesium Metal

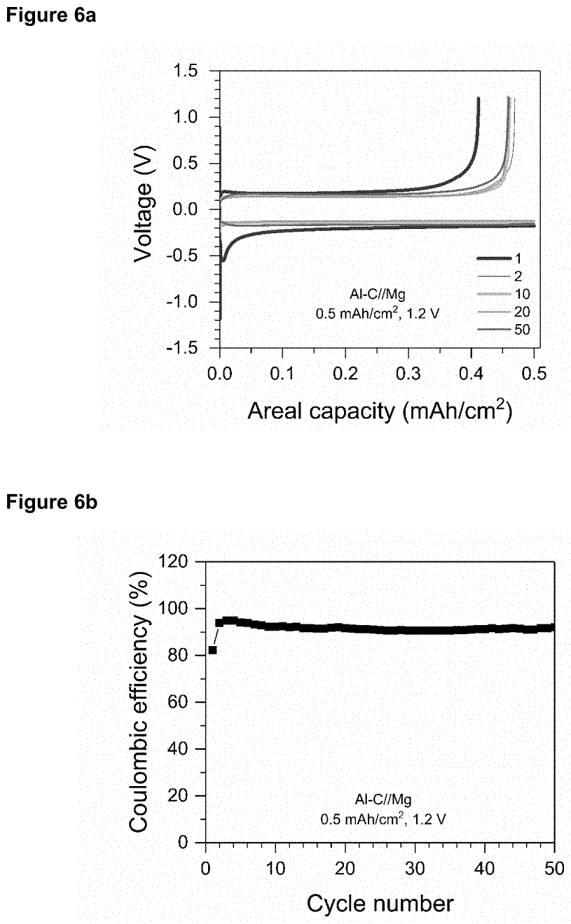

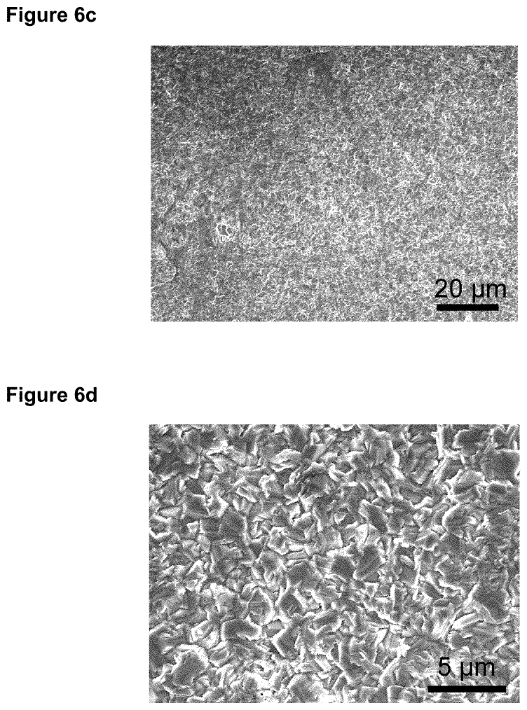

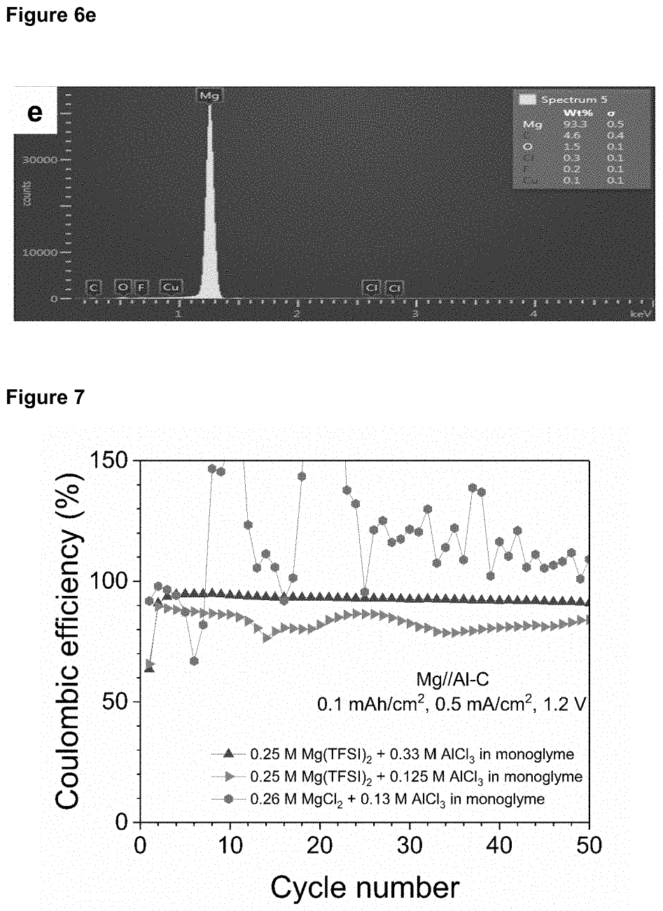

The morphology of magnesium metal deposits on the working electrode was studied via scanning electron microscopy. An electrochemical cell comprising a carbon-coated aluminium working electrode, magnesium disc counter electrode (also used as a reference electrode) and an electrolyte comprising 0.25 M Mg(TFSI)₂ and 0.33 M AlCl₃ in monoglyme was assembled. The cycling performance of the electrochemical cell is shown in FIGS. 5a and 5b; while scanning electron micrographs of magnesium deposits on a working electrode are provided in FIGS. 6c and 6d.

The voltage profile and Coulombic efficiency (FIGS. 5a and 5b) show that the assembled cell exhibits cycling performance at a high areal capacity of 0.5 mAh/cm². Examination of the magnesium deposition film on the working electrode revealed that there was uniform and non-dendritic morphologies even at high areal capacity (0.5 mAh/cm²) (FIG. 5c-d). This result indicates that the Mg(TFSI)₂—AlCl₃ electrolyte system enables homogeneous Mg deposition on Al—C electrode and therefore reduces short-circuit caused by dendrite growth.

Energy-dispersive X-ray spectroscopy (EDS) analysis of Mg deposition layer on Al—C electrolyte (FIG. 5e) confirmed the elemental composition of the magnesium film. The deposition layer consists of Mg as main component (93.3 wt %). Other elements, including CI, 0, F, and C, are from the surface film, which is believed to originate from the reduction and/or oxidation of electrolyte components at the surface of the electrode during cycling.

### Example 6. Comparison of Electrolyte Performance with Other Magnesium-Based Electrolyte Systems

The electrochemical performance of the electrolyte described herein was compared with that of a comparative electrolyte. To do so, a comparative electrolyte comprising a combination of 0.26 M MgCl₂ and 0.13 M AlCl₃, and an exemplary electrolyte comprising 0.25 M Mg(TFSI)₂ and 0.125 M AlCl₃ in monoglyme was prepared. Electrochemical cells comprising the comparative or exemplary electrolyte, an aluminium-carbon working electrode and a magnesium counter electrode (also used as the reference electrode) were fabricated for this study.

FIG. 7 compares the Coulombic efficiency (CE) of the exemplary electrolyte described herein and the comparative electrolyte solution. The plot shows that the electrolyte comprising 0.26 M MgCl₂+0.13 M AlCl₃ in monoglyme electrolyte (blue curve) shows higher initial CE (92%) than that of Mg(TFSI)₂—AlCl₃ based electrolytes. However, the Coulombic efficiency decreases significantly after 4 cycles and large variations of CE is observed in subsequent cycles. It indicates that severe degradation occurred in the Mg/Al—Cl cell comprising the MgCl₂—AlCl₃ system.

In contrast, the Mg(TFSI)₂—AlCl₃ based electrolyte with similar Mg²⁺ and Al³⁺ ratio (i.e. 0.25 M Mg(TFSI)₂ and 0.125 M AlCl₃ in monoglyme) demonstrated more stable performance. Despite the lower initial CE, the electrolyte comprising 0.25 M Mg(TFSI)₂ and 0.125 M AlCl₃ in monoglyme demonstrates a stable cycling performance with CE between 80-90%, which is maintained over 50 cycles.

Herein, it is noted that the performance of Mg(TFSI)₂—AlCl₃ based electrolytes may be dependent on the Mg:Cl ratio. It was found that optimal electrochemical performance of electrolyte solution can be achieved at a Mg:Cl ratio of 1:4, corresponding to the electrolyte formula of 0.25 M Mg(TFSI)₂ and 0.33 M AlCl₃ in monoglyme.

### INDUSTRIAL APPLICABILITY

The disclosed electrolyte may be used in electrochemical cells, particularly magnesium ion batteries. As such electrolytes allow efficient plating and stripping of magnesium from a working electrode, such electrolytes may be used for the fabrication and assembly of magnesium-ion batteries which may be used as energy sources in various electrical and electronic devices.

Due to its ease of manufacture, the electrolytes described herein may also be produced on an industrial scale for easy assembly of magnesium ion electrochemical cells, which may be used as an alternative energy storage system to presently available technologies.

1. An electrolyte comprising:
a) at least one magnesium salt;
b) an aluminium halide salt; and
c) a solvent comprising at least one ether group;
wherein the electrolyte does not comprise magnesium chloride; and
wherein said at least one magnesium salt comprises a polyatomic anion.

2. An electrolyte consisting essentially of:
a) a magnesium salt;
b) an aluminium halide salt; and
c) a solvent comprising at least one ether group;
wherein said magnesium salt comprises a polyatomic anion.

3. The electrolyte of claim 1, wherein the aluminium halide salt is aluminium fluoride, aluminium chloride, aluminium bromide or aluminium iodide.

4. The electrolyte of claim 1, wherein the aluminium halide salt is aluminium chloride.

5. The electrolyte of claim 1, wherein the electrolyte comprises at least two or more magnesium salts.

6. The electrolyte of claim 1, wherein the polyatomic anion of the magnesium salt is chlorate, trifluoromethanesulfonate (OTf), phosphate, sulfate, sulfite, hexafluorophosphate, hexafluoroarsenate, bis(trifluoromethanesulfonyl)imide (TFSI), bis(fluorosulfonyl)imide (FSI), bis(butanesulfonyl) imide, cyanamide, oligomeric fluorosulfonyl imide, nonafluorobutanesulfonyl imide, bis(oxalato)borate (BOB), difluoro(oxalato)borate (DFOB), or tetrafluoroborate.

7. The electrolyte of claim 1, wherein the polyatomic anion of said magnesium salt is bis(trifluoromethanesulfonyl)imide.

8. The electrolyte of claim 1, wherein the solvent comprises less than 200 ppm water.

9. The electrolyte of claim 1, wherein the solvent comprises less than 20 ppm water.

10. The electrolyte of claim 1, wherein the concentration of the magnesium salt is between 0.01 M to 20 M.

11. The electrolyte of claim 1, wherein the concentration of the magnesium salt is between 0.2 M to 0.5 M.

12. The electrolyte of claim 1, wherein the concentration of the aluminium halide salt is between 0.01 M to 20 M.

13. The electrolyte of claim 1, wherein the concentration of the aluminium halide salt is between 0.2 M to 0.6 M.

14. The electrolyte of claim 1, wherein the molar ratio of the magnesium salt to the aluminium halide salt is between 5:1 to 1:10.

15. The electrolyte of claim 1, wherein the molar ratio of the magnesium salt to the aluminium halide salt is about 1:1.32.

16. The electrolyte of claim 1, wherein the solvent is selected from the group consisting of tetrahydrofuran, monoglyme, diglyme, triglyme, tetraglyme, dioxane, tetrahydropyran and combinations thereof.

17. The electrolyte of claim 1, wherein the solvent is monoglyme.

18. An electrochemical cell comprising:
a) a positive electrode;
b) a magnesium negative electrode; and
c) an electrolyte comprising:
i) at least one magnesium salt;
ii) an aluminium halide salt; and
iii) a solvent comprising at least one ether group;
wherein the electrolyte does not comprise magnesium chloride;
wherein said at least one magnesium salt comprises a polyatomic anion;
wherein said positive electrode and said magnesium negative electrode are in fluid communication with said electrolyte.

19. The electrochemical cell of claim 18, wherein the electrolyte is absorbed on a separator located between said positive electrode and said magnesium negative electrode.

20. The electrochemical cell of claim 18, wherein the positive electrode is fabricated from a sulfur composite or a complex comprising a transition metal.
